(19) United States
(12) Patent Application Publication
(10) Pub. No.: US 2025/0048396 A1
(43) Pub. Date: Feb. 6, 2025

(54) SIDELINK FEEDBACK MESSAGING

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Luanxia YANG, Beijing (CN); Siyi CHEN, Beijing (CN); Hao XU, Beijing (CN)

(21) Appl. No.: 18/720,012

(22) PCT Filed: Feb. 28, 2022
(86) PCT No.: PCT/CN2022/078164

§ 371 Date: Jun. 14, 2024

(51) Int. Cl. H04W 72/25; H04L 5/00; H04W 72/56

(52) U.S. Cl. CPC H04W 72/25; H04L 5/0094; H04W 72/56

(57) ABSTRACT

Various aspects of the present disclosure generally relate to wireless communication. In some aspects, a user equipment (UE) may receive a first one or more physical sidelink shared channel communications associated with a first set of physical sidelink shared channel priorities and associated with a first feedback message codebook. The UE may receive a second one or more physical sidelink shared channel communications associated with a second set of physical sidelink shared channel priorities and associated with a second feedback message codebook. The UE may include transmit, based at least in part on a physical sidelink feedback channel feedback resource configuration, a first feedback message in a first physical sidelink feedback channel feedback resource and a second feedback message in a second physical sidelink feedback channel feedback resource.

### FIELD OF THE DISCLOSURE

Aspects of the present disclosure generally relate to wireless communication and to techniques and apparatuses for sidelink feedback messaging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE. NR, and other radio access technologies remain useful.

### SUMMARY

Some aspects described herein relate to a method of wireless communication performed by a user equipment (UE). The method may include receiving a first one or more physical sidelink shared channel communications associated with a first set of physical sidelink shared channel priorities, of a plurality of physical sidelink shared channel priorities, and associated with a first feedback message codebook. The method may include receiving a second one or more physical sidelink shared channel communications associated with a second set of physical sidelink shared channel priorities, of the plurality of physical sidelink shared channel priorities, and associated with a second feedback message codebook. The method may include transmitting, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to a method of wireless communication performed by a UE. The method may include receiving a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The method may include receiving a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time. The method may include transmitting a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to a method of wireless communication performed by a UE. The method may include transmitting a first one or more physical sidelink shared channel communications associated with a first set of physical sidelink shared channel priorities, of a plurality of physical sidelink shared channel priorities, and associated with a first feedback message codebook. The method may include transmitting a second one or more physical sidelink shared channel communications associated with a second set of physical sidelink shared channel priorities, of the plurality of physical sidelink shared channel priorities, and associated with a second feedback message codebook. The method may include receiving, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to a method of wireless communication performed by a UE. The method may include transmitting a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The method may include transmitting a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time. The method may include receiving a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to a UE for wireless communication. The UE may include a memory and one or more processors coupled to the memory. The one or more processors may be configured to receive a first one or more physical sidelink shared channel communications associated with a first set of physical sidelink shared channel priorities, of a plurality of physical sidelink shared channel priorities, and associated with a first feedback message codebook. The one or more processors may be configured to receive a second one or more physical sidelink shared channel communications associated with a second set of physical sidelink shared channel priorities, of the plurality of physical sidelink shared channel priorities, and associated with a second feedback message codebook. The one or more processors may be configured to transmit, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to a UE for wireless communication. The UE may include a memory and one or more processors coupled to the memory. The one or more processors may be configured to receive a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The one or more processors may be configured to receive a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource. The one or more processors may be configured to transmit a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to a UE for wireless communication. The UE may include a memory and one or more processors coupled to the memory. The one or more processors may be configured to transmit a first one or more physical sidelink shared channel communications associated with a first set of physical sidelink shared channel priorities, of a plurality of physical sidelink shared channel priorities, and associated with a first feedback message codebook. The one or more processors may be configured to transmit a second one or more physical sidelink shared channel communications associated with a second set of physical sidelink shared channel priorities, of the plurality of physical sidelink shared channel priorities, and associated with a second feedback message codebook. The one or more processors may be configured to receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to a UE for wireless communication. The UE may include a memory and one or more processors coupled to the memory. The one or more processors may be configured to transmit a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The one or more processors may be configured to transmit a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource. The one or more processors may be configured to receive a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to a non-transitory computer-readable medium that stores a set of instructions for wireless communication by a UE. The set of instructions, when executed by one or more processors of the UE, may cause the UE to receive a first one or more physical sidelink shared channel communications associated with a first set of physical sidelink shared channel priorities, of a plurality of physical sidelink shared channel priorities, and associated with a first feedback message codebook. The set of instructions, when executed by one or more processors of the UE, may cause the UE to receive a second one or more physical sidelink shared channel communications associated with a second set of physical sidelink shared channel priorities, of the plurality of physical sidelink shared channel priorities, and associated with a second feedback message codebook. The set of instructions, when executed by one or more processors of the UE, may cause the UE to transmit, based at least in part on a physical sidelink feedback channel feedback resource configuration, a first feedback message in a first physical sidelink feedback channel feedback resource associated with the first in feedback message codebook and a second feedback message in a second physical sidelink feedback channel feedback resource associated with the second feedback message codebook.

Some aspects described herein relate to a non-transitory computer-readable medium that stores a set of instructions for wireless communication. The set of instructions, when executed by one or more processors of an UE, may cause the UE to receive a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The set of instructions, when executed by one or more processors, may cause the UE to receive a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource. The set of instructions, when executed by one or more processors, may cause the UE to transmit a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to a non-transitory computer-readable medium that stores a set of instructions for wireless communication. The set of instructions, when executed by one or more processors, may cause the UE to transmit a first one or more physical sidelink shared channel communications associated with a first set of physical sidelink shared channel priorities, of a plurality of physical sidelink shared channel priorities, and associated with a first feedback message codebook. The set of instructions, when executed by one or more processors, may cause the UE to transmit a second one or more physical sidelink shared channel communications associated with a second set of physical sidelink shared channel priorities, of the plurality of physical sidelink shared channel priorities, and associated with a second feedback message codebook. The set of instructions, when executed by one or more processors, may cause the UE to receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to a non-transitory computer-readable medium that stores a set of instructions for wireless communication. The set of instructions, when executed by one or more processors, may cause the UE to transmit a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The set of instructions, when executed by one or more processors, may cause the UE to transmit a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource. The set of instructions, when executed by one or more processors, may cause the UE to receive a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to an apparatus for wireless communication. The apparatus may include means for receiving a first one or more physical sidelink shared channel communications associated with a first set of physical sidelink shared channel priorities, of a plurality of physical sidelink shared channel priorities, and associated with a first feedback message codebook. The apparatus may include means for receiving a second one or more physical sidelink shared channel communications associated with a second set of physical sidelink shared channel priorities, of the plurality of physical sidelink shared channel priorities, and associated with a second feedback message codebook. The apparatus may include means for transmitting, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to an apparatus for wireless communication. The apparatus may include means for receiving a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The apparatus may include means for receiving a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time. The apparatus may include means for transmitting a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Some aspects described herein relate to an apparatus for wireless communication. The apparatus may include means for transmitting a first one or more physical sidelink shared channel communications associated with a first set of physical sidelink shared channel priorities, of a plurality of physical sidelink shared channel priorities, and associated with a first feedback message codebook. The apparatus may include means for transmitting a second one or more physical sidelink shared channel communications associated with a second set of physical sidelink shared channel priorities, of the plurality of physical sidelink shared channel priorities, and associated with a second feedback message codebook. The apparatus may include means for receiving, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Some aspects described herein relate to an apparatus for wireless communication. The apparatus may include means for transmitting a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource. The apparatus may include means for transmitting a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time. The apparatus may include means for receiving a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (RAN) (O-RAN) architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a sidelink resource assignment for sidelink feedback messaging, in accordance with the present disclosure.

FIGS. 7A-7E are diagrams illustrating examples associated with sidelink feedback messaging, in accordance with the present disclosure.

FIGS. 8-11 are diagrams illustrating example processes associated with sidelink feedback messaging, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

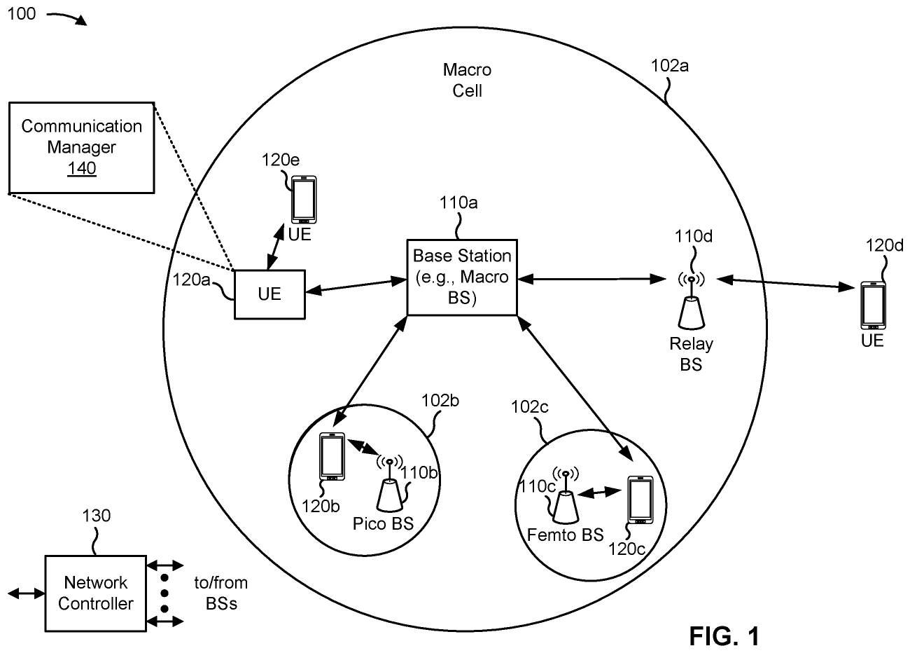

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ). FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first one or more physical sidelink shared channel communications associated with a first set of physical sidelink shared channel priorities, of a plurality of physical sidelink shared channel priorities, and associated with a first feedback message codebook: receive a second one or more physical sidelink shared channel communications associated with a second set of physical sidelink shared channel priorities, of the plurality of physical sidelink shared channel priorities, and associated with a second feedback message codebook; and transmit, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Additionally, or alternatively, the communication manager 140 may receive a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource: receive a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time; and transmit a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

Additionally, or alternatively, the communication manager 140 may transmit a first one or more physical sidelink shared channel communications associated with a first set of physical sidelink shared channel priorities, of a plurality of physical sidelink shared channel priorities, and associated with a first feedback message codebook: transmit a second one or more physical sidelink shared channel communications associated with a second set of physical sidelink shared channel priorities, of the plurality of physical sidelink shared channel priorities, and associated with a second feedback message codebook; and receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Additionally, or alternatively, the communication manager 140 may transmit a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource: transmit a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time; and receive a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities. Additionally, or alternatively, the communication manager 140 may perform one or more other operations described herein.

As indicated above. FIG. 1 is provided as an example. Other examples may differ from what is described with regard to FIG. 1.

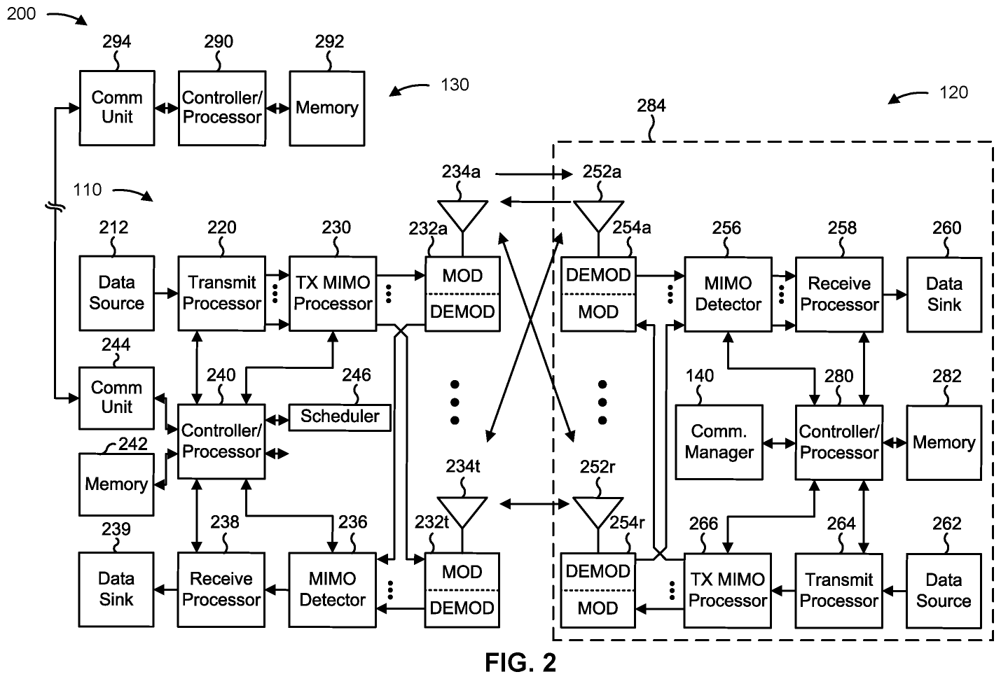

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

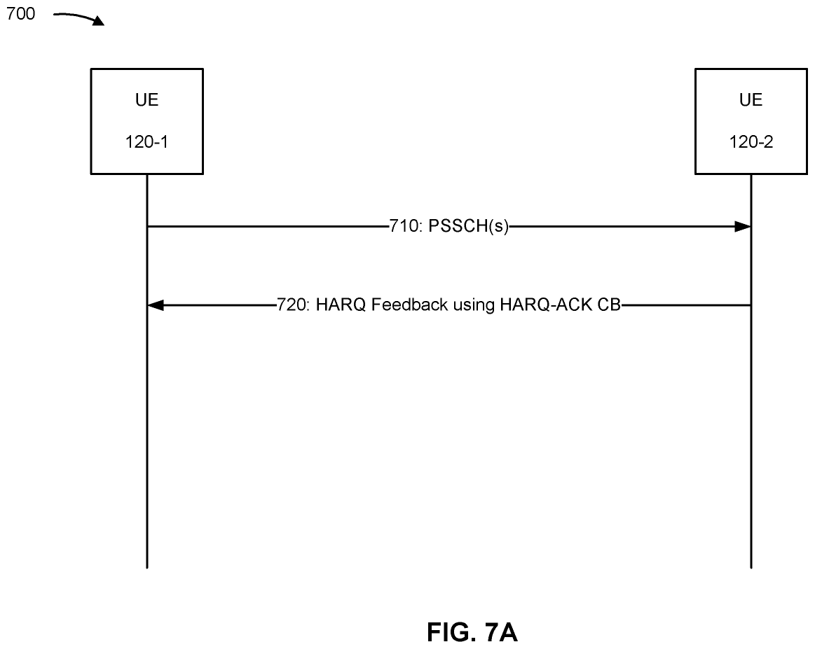

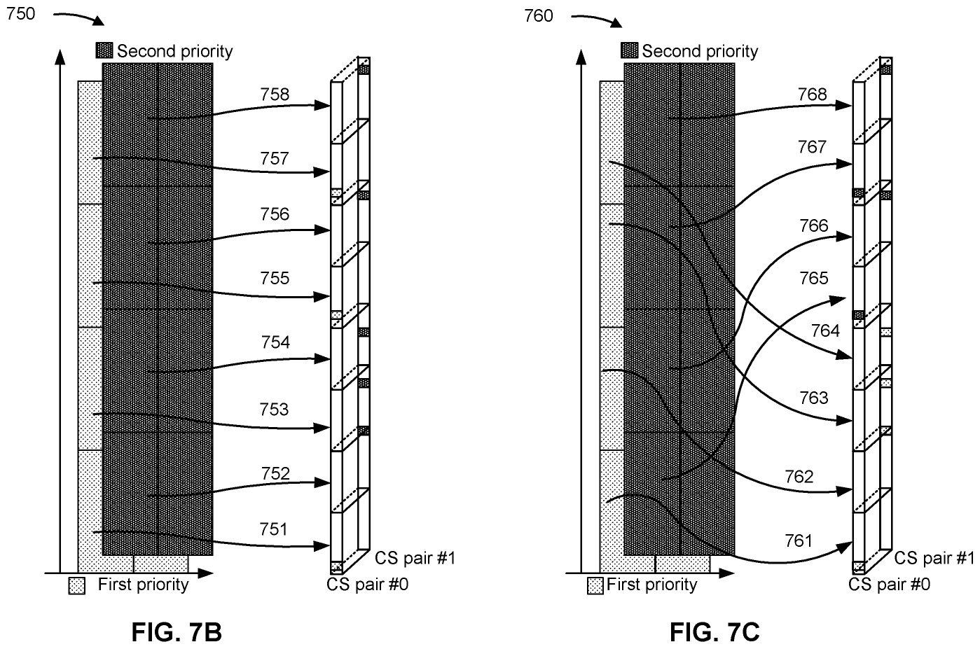

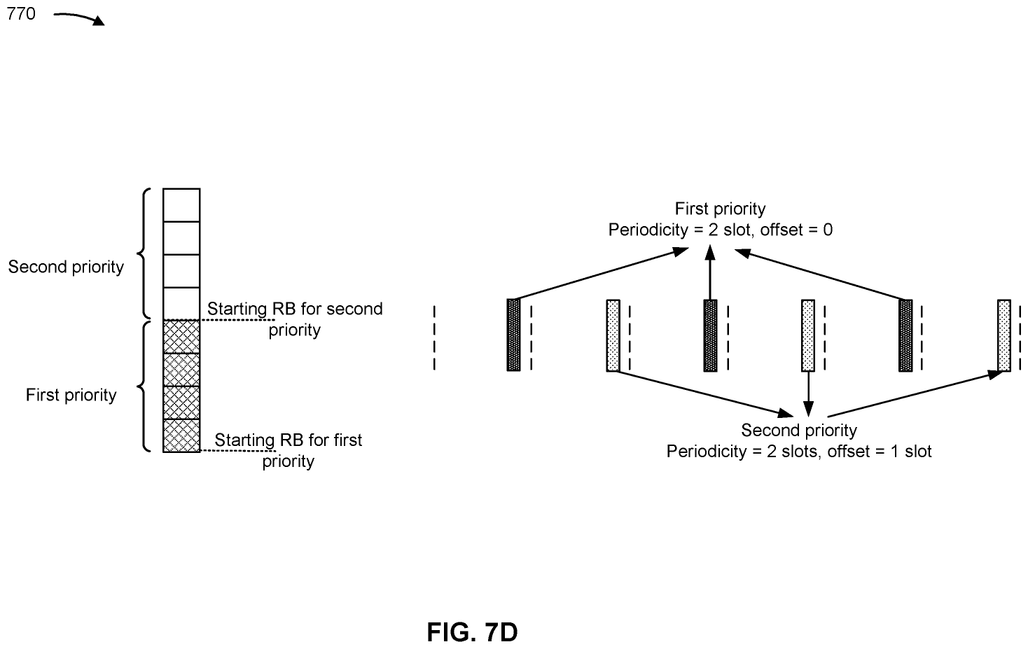

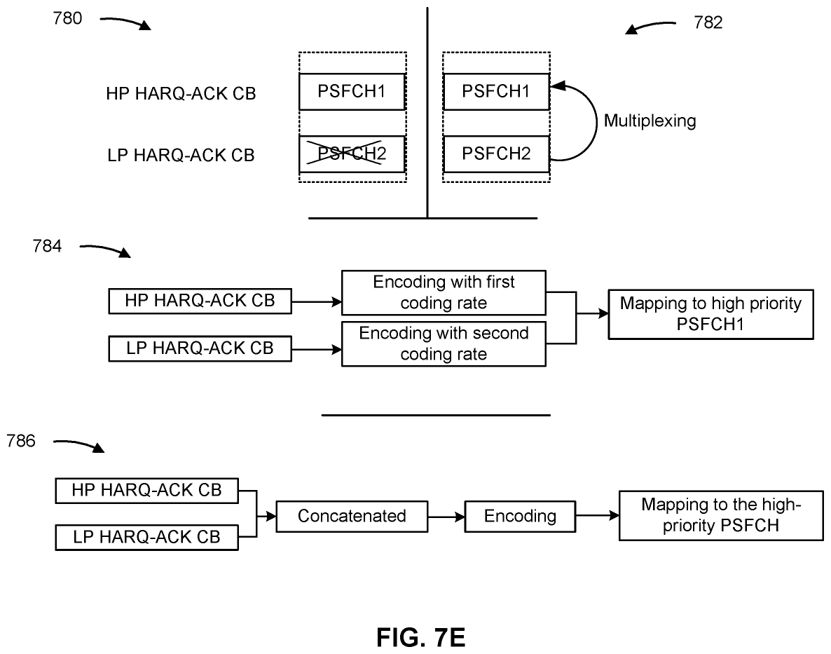

On the uplink, at the UE 120, a transmit processor 264 may receive and process data from a data source 262 and control information (e.g., for reports that include RSRP. RSSI. RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-12).

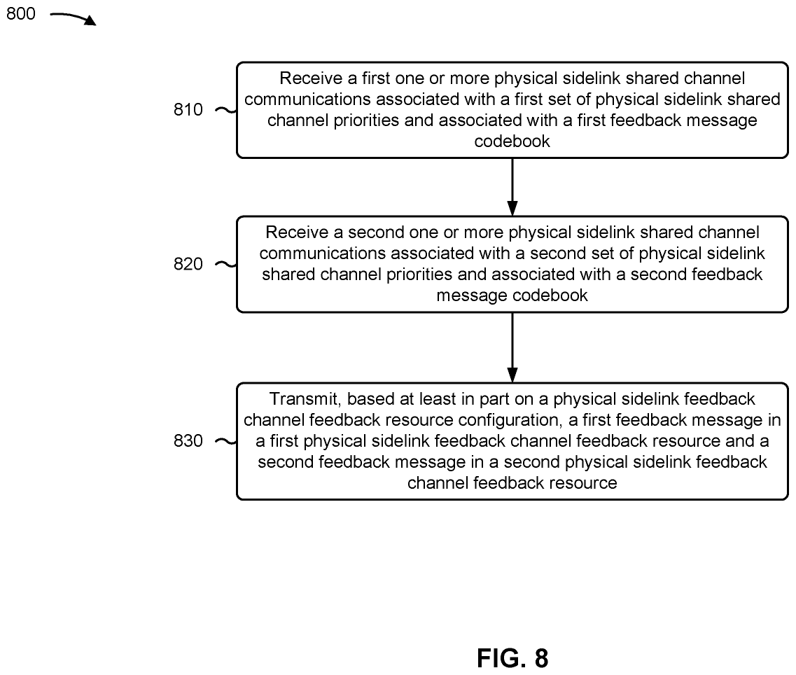

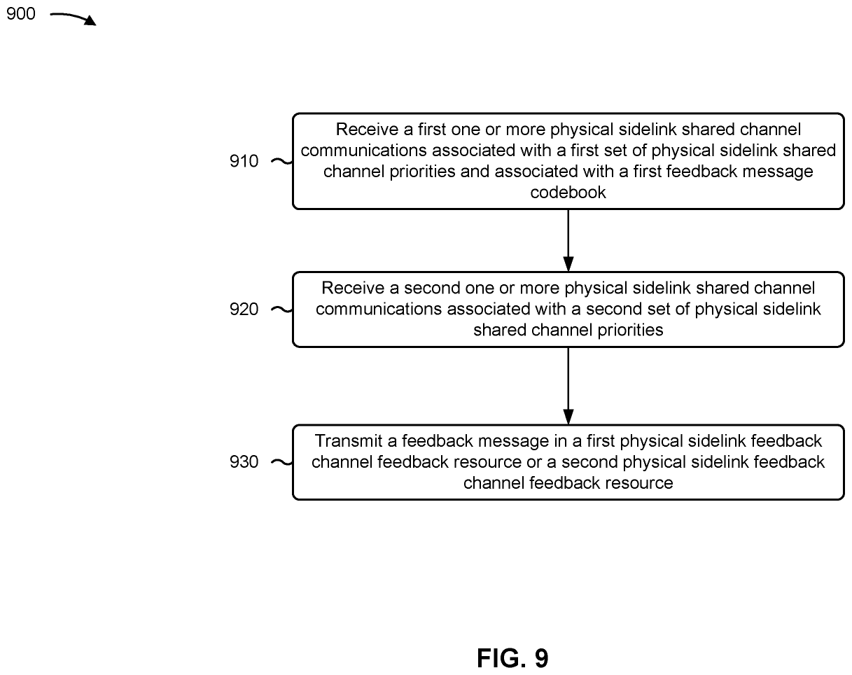

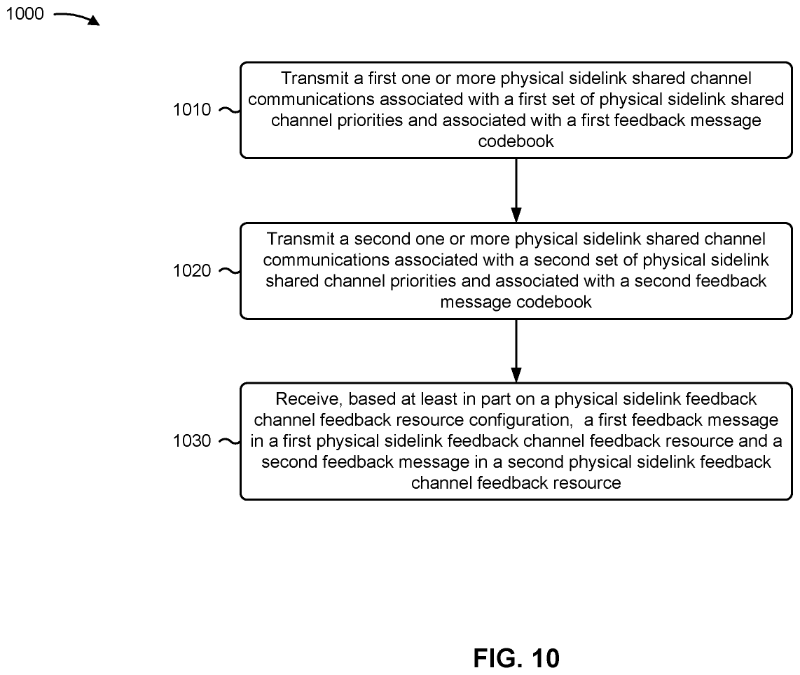

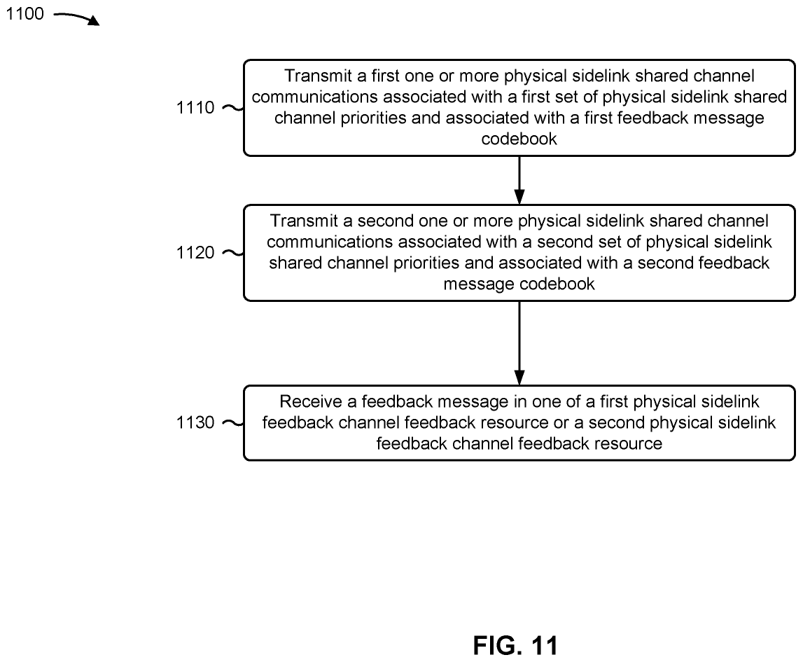

The controller/processor 240 of the base station 110, the controller/processor 280 of the UE 120, and/or any other component(s) of FIG. 2 may perform one or more techniques associated with sidelink feedback messaging, as described in more detail elsewhere herein. In some aspects, the network entity described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., UE 120) includes means for receiving a first one or more physical sidelink shared channel communications associated with a first set of physical sidelink shared channel priorities, of a plurality of physical sidelink shared channel priorities, and associated with a first feedback message codebook: means for receiving a second one or more physical sidelink shared channel communications associated with a second set of physical sidelink shared channel priorities, of the plurality of physical sidelink shared channel priorities, and associated with a second feedback message codebook; and/or means for transmitting, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

In some aspects, the UE includes means for receiving a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource: means for receiving a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time; and/or means for transmitting a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities.

In some aspects, the UE includes means for transmitting a first one or more physical sidelink shared channel communications associated with a first set of physical sidelink shared channel priorities, of a plurality of physical sidelink shared channel priorities, and associated with a first feedback message codebook: means for transmitting a second one or more physical sidelink shared channel communications associated with a second set of physical sidelink shared channel priorities, of the plurality of physical sidelink shared channel priorities, and associated with a second feedback message codebook; and/or means for receiving, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

In some aspects, the UE includes means for transmitting a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource: means for transmitting a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, where the first physical sidelink feedback channel feedback resource and the second physical sidelink feedback channel feedback resource are at least partially overlapping in time; and/or means for receiving a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities. The means for the UE (e.g., the UE 120) to perform operations described herein may include, for example, one or more of communication manager 140, antenna 252, modem 254. MIMO detector 256, receive processor 258, transmit processor 264. TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

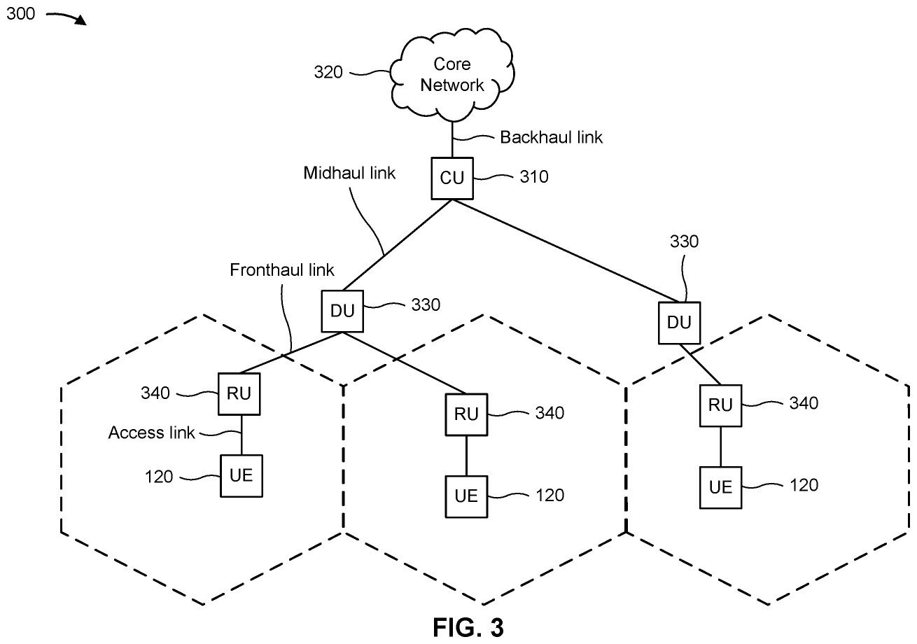

FIG. 3 is a diagram illustrating an example 300 of an open RAN (O-RAN) architecture, in accordance with the present disclosure. As shown in FIG. 3, the O-RAN architecture may include a control unit (CU) 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUS (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above. FIG. 3 is provided as an example. Other examples may differ from what is described with regard to FIG. 3.

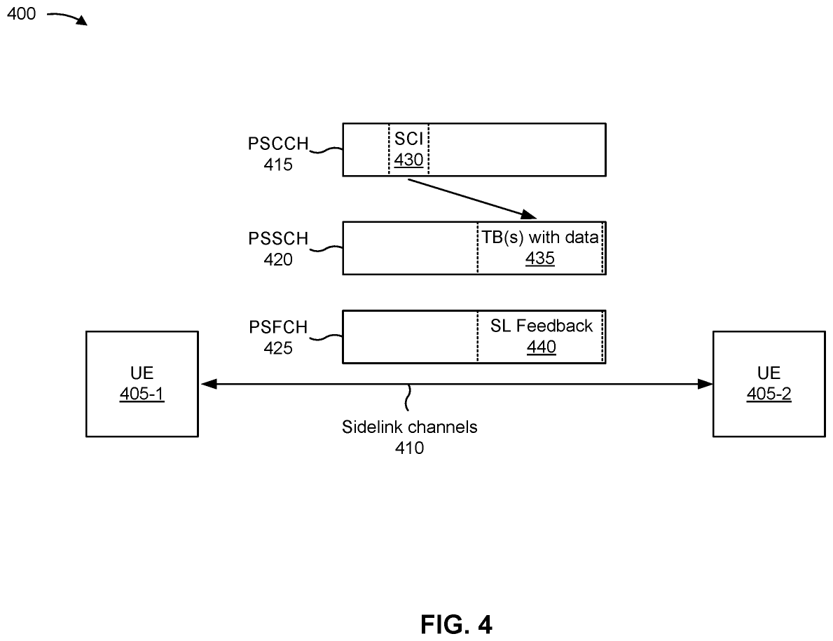

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels+10 for peer-to-peer (P2P) communications, device-to-device (D2D) communications, vehicle-to-everything (V2X) communications (e.g., which may include vehicle-to-vehicle (V2V) communications, vehicle-to-infrastructure (V2I) communications, and/or vehicle-to-pedestrian (V2P) communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

The one or more sidelink channels 410 may use resource pools. For example, a scheduling assignment (e.g., included in SCI 430) may be transmitted in sub-channels using specific resource blocks (RBs) across time. Data transmissions (e.g., on the PSSCH 420) associated with a scheduling assignment may occupy adjacent RBs in the same subframe as the scheduling assignment (e.g., using frequency division multiplexing). A scheduling assignment and associated data transmissions may not be transmitted on adjacent RBs.

A UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. A UE 405 may operate using a transmission mode (e.g., Mode 2) where resource selection and/or scheduling is performed by the UE 405 (e.g., rather than a base station 110). The UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. A UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above. FIG. 4 is provided as an example. Other examples may differ from what is described with respect to FIG. 4.

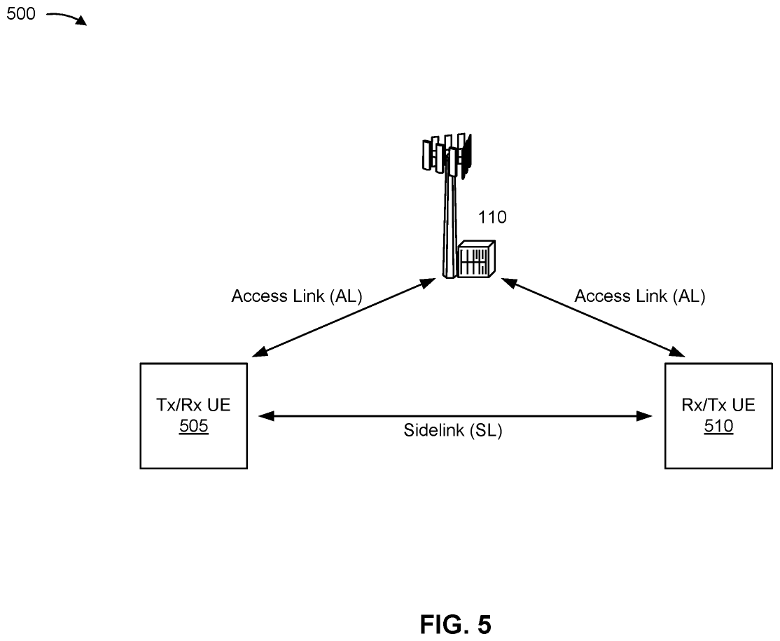

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a base station 110 may communicate with the Tx/Rx UE 505 via a first access link. Additionally, or alternatively, in some sidelink modes, the base station 110 may communicate with the Rx/Tx UE 510 via a second access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above. FIG. 5 is provided as an example. Other examples may differ from what is described with respect to FIG. 5.

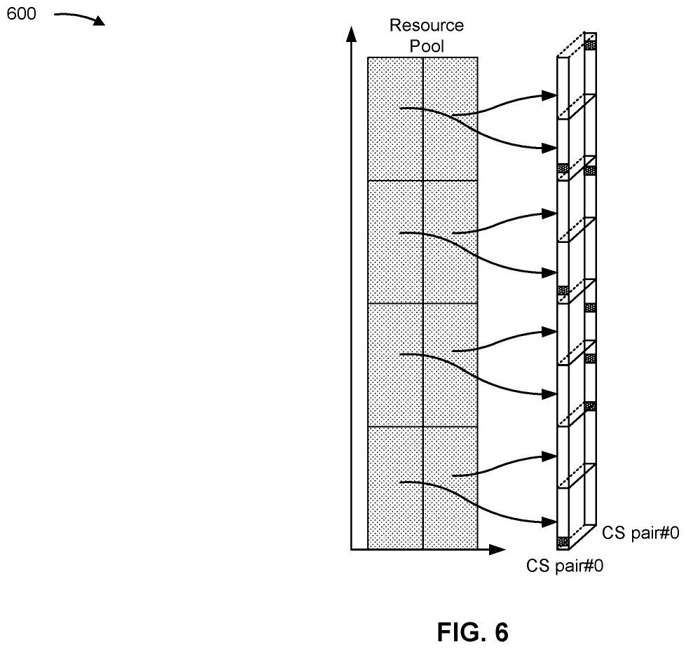

FIG. 6 is a diagram illustrating an example 600 of a sidelink resource assignment for sidelink feedback messaging, in accordance with the present disclosure.

As shown in FIG. 6, a resource pool may include resources that can be allocated for PSFCH transmission of a hybrid automatic feedback request (HARQ) feedback message (e.g., a HARQ acknowledgement (ACK) or a HARQ negative acknowledgement (NACK)). For example, when a first UE transmits a PSCCH or PSSCH transmission, the first UE may trigger a second UE to transmit ACK or NACK (ACK/NACK or A/N) feedback indicating whether the second UE successfully received and decoded the PSCCH or PSSCH transmission. The second UE may select a PSFCH resource from the resource pool, which is not a dedicated PSFCH resource pool (e.g., the resource pool includes resources allocated for PSFCH transmission and other transmissions).

PSFCH resources within the resource pool may be associated with a periodicity parameter (periodPSFCHresource) that indicates a period (e.g., in slots) for PSFCH transmission in the resource pool. For example, the periodicity parameter may be configured with a value of 0, 1, 2, or 4, where ‘0’ indicates no PSFCH resources are available within the resource pool and ‘1’, ‘2’, and ‘4’ indicate a periodicity of 1 slot. 2 slots, or 4 slots, respectively, for PSFCH resources within the resource pool. PSFCH transmission is to occur within a first slot with a PSFCH resource after the triggering transmission and a time gap. For example, the second UE may transmit a PSFCH in a first slot, which includes a PSFCH resource, occurring a configured time gap (e.g., a parameter (MinTimeGapPSFCH)) after the second UE receives or fails to receive a PSSCH.

Physical resource blocks (PRBs) that the second UE is to use for PSFCH transmission are configured based at least in part on a parameter (sl-PSFCH-RB-Set). Each subchannel for a given slot may have a quantity of

$${M}_{subch , slot}^{PSFCH} = \frac{{M}_{PRB , set}^{PSFCH}}{{N}_{PSSCH}^{PSFCH} \times {N}_{subch}}$$

PRBs, where M_{PRB,set}^{PSFCH} is a quantity of PRBs configured by sl-PSFCH-RB-Set, N_{PSSCH}^{PSFCH} is a quantity of PSSCH slots corresponding to a single PSFCH slot, and N_{subch} is a quantity of PSSCH subchannels in a PSSCH slot. Mapping of PSSCH resources to PSFCH PRBs may occur on a time first mapping basis, where an order, in time, with which A/Ns are mapped to PSFCH PRBs is based at least in part on an order, in time, of PSSCH resources to which the A/Ns are subject. A total PSFCH resource pool is of a size R_{PRB,CS}^{PSFCH}=N_{type}^{PSFCH}×N_{CS}^{PSFCH}×M_{subch,slot}^{PSFCH}, where R_{PRB,CS}^{PSFCH} is the quantity of PSFCH resources. N_{type}^{PSFCH} is a parameter related to a quantity of subchanneles in a PSSCH slot and whether a PSFCH resource pool is shared with other transmissions, and N_{CS}^{PSFCH} is a quantity of cyclic shift pairs configured per resource pool. The second UE may determine a PSFCH resource that the second UE is to use as (P_{ID}+M_{ID}) mod R_{PRB,CS}^{PSFCH}. Where P_{ID} is a physical source identifier (e.g., from an SCI 2-A or SCI 2-B message) for a PSSCH and M_{ID} is a parameter based at least in part on an identity of the second UE and based at least in part on a cast type of the PSSCH. Additional details regarding PSFCH resources are found in 3GPP Technical Specification (TS) 38.213. Release 16. Version 16.8.0.

As indicated above. FIG. 6 is provided as an example. Other examples may differ from what is described with respect to FIG. 6.

As described above, a first UE may transmit a PSSCH or PSCCH communication to a second UE and the second UE may transmit HARQ feedback to indicate whether the second UE is successful in receiving and decoding the PSSCH or PSCCH communication. The second UE may determine a resource with which to transmit the HARQ feedback based at least in part on a codebook, such as a sidelink HARQ ACK codebook (SL ACK CB) for PSSCH. Different PSSCH transmissions may have different priorities, which may result in corresponding HARQ feedback transmissions having different priorities. As a first example, the second UE may be configured to use a joint HARQ-ACK CB that is applicable across the different priorities. In other words, in the first example, the second UE may be configured with a single HARQ-ACK CB that the second UE uses for determining resources for HARQ feedback associated with both a high-priority PSSCH and a low-priority PSSCH. As a second example, the second UE may be configured to select a HARQ-ACK CB that is applicable to the particular priority of the PSSCH for which the second UE is transmitting HARQ feedback. In other words, in the second example, the second UE may be configured with a first HARQ-ACK CB for determining resources for HARQ feedback associated with the high-priority PSSCH and a second HARQ-ACK CB for determining resources for HARQ feedback associated with the low-priority PSSCH.

With regard to the second example, the different HARQ-ACK CBs may result in the second UE transmitting different HARQ feedback messages using different PSFCH resources. However, the second UE and the first UE may lack synchronization regarding whether the HARQ feedback messages are to use the same PSFCH resource configuration or different PSFCH resource configurations. Accordingly, the first UE may fail to receive the different HARQ feedback messages. With further regard to the second example, when using the different HARQ-ACK CBs, the second UE may identify a single resource that two different HARQ-ACK CBs indicate the second UE is to use for transmitting two different HARQ feedback messages. In another example, the second UE may identify two different resources that two HARQ-ACK CB is to use for transmission and the two different resources may occur in the same slot. However, the UE may not be able to transmit both of the HARQ-Ack CBs due to the UE capability or power limitation. The second UE and the first UE may lack synchronization regarding how to handle such a collision, which may result in the first UE failing to accurately map a received HARQ feedback message to the PSSCH that triggered the received HARQ feedback message.

Some aspects described herein enable use of a HARQ-ACK CB for sidelink feedback messaging. For example, a UE may be configured with common PSFCH resources for different HARQ-ACK CBs associated with different PSSCH priorities. In this case, the UE may partition PSFCH resource blocks (RBs) based at least in part on sub-channels and for the different HARQ-ACK CBs. Additionally, or alternatively, the UE may be configured with separate PSFCH resources for the different HARQ-ACK CBs. Additionally, or alternatively, when a collision occurs between different HARQ-ACK CBs (e.g., the different HARQ-ACK CBs are to be transmitted in a common resource for transmitting different HARQ feedback messages associated with different PSSCHs with different priorities), the UE may transmit a single HARQ-ACK CB HARQ feedback message (and drop another HARQ-ACK CB HARQ feedback message) or multiplex the different HARQ feedback messages based at least in part on a received configuration. In this way, the UE deterministically manages HARQ feedback messages such that the other UE can successfully receive the HARQ feedback messages.

FIGS. 7A-7E are diagrams illustrating an example 700 of sidelink feedback messaging, in accordance with the present disclosure. As shown in FIG. 7A, a first UE 120-1 and a second UE 120-2 may communicate with one another.

As shown by reference number 710, the first UE 120-1 may transmit one or more PSSCH communications to the second UE 120-2. For example, the first UE 120-1 may transmit a PSSCH communications with a priority (e.g., a PSSCH priority), of a set of priorities (e.g., PSSCH priorities), to the second UE 120-2. In some aspects, the first UE 120-1 may transmit and the second UE 120-2 may receive a plurality of PSSCH communications. For example, the second UE 120-2 may receive a first one or more PSSCH communications with one or more lower priorities (e.g., priorities 0-3) and one or more second PSSCH communications with one or more higher priorities (e.g., priorities 4-7).

As shown by reference number 720, the second UE 120-2 may transmit a feedback message to the first UE 120-1. For example, the second UE 120-2 may transmit HARQ feedback generated based at least in part on the PSSCH communication. In this case, the second UE 120-2 may transmit a HARQ ACK to indicate successful receipt of a PSSCH communication, or a HARQ NACK to indicate unsuccessful receipt of the PSSCH communication.

In some aspects, the second UE 120-2 may generate a feedback message based at least in part on a feedback message codebook, such as an SL HARQ-ACK CB. For example, the second UE 120-2 may determine a resource in which to transmit HARQ feedback based at least in part on a configuration of an SL HARQ-ACK CB. In this case, the SL HARQ-ACK CB that the second UE 120-2 uses may be specific to a priority of the PSSCH communication for which the second UE 120-2 is to transmit HARQ feedback. For example, the second UE 120-2 may use a first, high priority SL HARQ-ACK CB for generating first, high priority HARQ feedback corresponding to a first, high priority PSSCH communication. Similarly, the second UE 120-2 may use a second, low priority SL HARQ-ACK CB for generating second, low priority HARQ feedback corresponding to a second, low priority PSSCH communication.

In some aspects, an SL HARQ-ACK CB may relate to a plurality of priorities. For example, the first UE 120-2 may receive a first one or more PSSCH communications associated with a first set of PSSCH priorities (e.g., priorities 0-3) corresponding to a first SL HARQ-ACK CB and a second one or more PSSCH communications associated with a second set of PSSCH priorities (e.g., priorities 4-7) corresponding to a second SL HARQ-ACK CB. In this case, each SL HARQ-ACK CB covers a range of priorities rather than a single priority. Additionally, or alternatively, a first SL HARQ-ACK CB may cover a single priority and a second SL HARQ-ACK CB may cover a plurality of priorities.

In some aspects. SL HARQ-ACK CBs may differ with regard to one or more parameters, such as a periodicity with which PSFCH resources are available or a channel or subchannel on which to select PSFCH resources, among other examples. Although some aspects are described herein in terms of a first priority and a second priority or a high priority and a low priority, any number of priorities may be used.

In some aspects, a single PSFCH may convey HARQ feedback associated with different slots. For example, the single PSFCH may have partitioned PSFCH resource blocks corresponding to different priorities of PSSCHs. In this case, the second UE 120-2 may map HARQ feedback messages to sub-channels of the single PSFCH based at least in part on a selected SL HARQ-ACK CB and the partitioning of resource blocks. In other words, the second UE 120-2 may have a high priority HARQ feedback message associated with a high priority SL HARQ-ACK CB to a first resource block partition associated with a high priority, and a low priority HARQ feedback message associated with a low priority SL HARQ-ACK CB to a second resource block partition associated with a low priority.

In some aspects, a common PSFCH resource may be configured for use with different SL HARQ-ACK CBs associated with different PSSCH priorities. For example, for a multi-bit PSFCH resource pool. PSFCH resource blocks are partitioned (into a plurality of partitions) based at least in part on subchannel and SL HARQ-ACK CB priorities with hashing based at least in part on a layer 1 (L1) UE identifier of the first UE 120-1 (e.g., the transmitting UE) and a groupcast identifier associated with a resource block group. In other words, the second UE 120-2 may map a single PSSCH subchannel with a particular priority to a PSFCH resource block group with the particular priority, where the size of the PSFCH resource block group is

$${M}_{subch , priority}^{PSFCH} = \frac{{M}_{PRB , set}^{PSFCH}}{Npriority \times {N}_{subch}}$$

physical resource blocks. In some cases, for PSFCH carrying different HARQ-ACK CBs associated with different PSSCH priorities, different coding rate can be configured if PSFCH format 2 is configured.

In some aspects, the second UE 120-2 may map a HARQ feedback message to the PSFCH on a priority first, frequency second basis, as shown in FIG. 7B and by reference number 750. In this case, a first subchannel associated with a first priority maps to a first PSFCH RBG as shown by reference number 751, a first subchannel associated with a second priority maps to a second PSFCH RBG as shown by reference number 752, a second subchannel associated with a first priority maps to a third PSFCH RBG as shown by reference number 753, a second subchannel associated with a second priority maps to a fourth PSFCH RBG as shown by reference number 754. Similarly, the third subchannel associated with a first priority maps to a fifth PSFCH RBG, the third channel associated with a second priority maps to a sixth PSFCH RBG, the fourth subchannel associated with a first priority maps to a seventh PSFCH RBG and the fourth subchannel associated with a second priority maps to the eight PSFCH RBG. The fifth through eight PSFCH RBG are ordered as shown by reference numbers 755-758.

In contrast, the second UE 120-2 may map a HARQ feedback message to the PSFCH on a frequency first, priority second basis, as shown in FIG. 7C and by reference number 760. In this case, the first subchannel associated with the first priority maps to the first PSFCH RBG as shown by reference number 761, the second subchannel associated with the first priority maps to the second PSFCH RBG as shown by reference number 762, the third subchannel associated with the first priority maps to the third PSFCH RBG as shown by reference number 763, the fourth subchannel associated with the first priority maps to the fourth PSFCH RBG as shown by reference number 764. Similarly, the first to fourth subchannel associated with the second priority map to the fifth to eight PSFCH RBG respectively as shown by reference numbers 765-768.

In some aspects, the second UE 120-2 may determine a number of PSFCH resources available for multiplexing HARQ-ACK feedback in a PSFCH transmission

$${R}_{PRB , CS}^{PSFCH} = {N}_{type}^{PSFCH} \times {N}_{CS}^{PSFCH} \times ⌊ \frac{{M}_{subch , priority}^{PSFCH}}{N} ⌋$$

where N_{CS}^{PSFCH} is a number of cyclic shift pairs for the resource pool provided by sl-NumMuxCS-Pair, N is the number of PRBs allocated to a PSFCH resource and, based on an indication by sl-PSFCH-CandidateResourceType, if sl-PSFCH-CandidateResourceType is configured as startSubCH, N_{type}^{PSFCH}=1 and the M_{subch,priority}^{PSFCH} are associated with the starting sub-channel of the corresponding PSSCH and the priority of the corresponding PSSCH; if sl-PSFCH-CandidateResourceType is configured as allocSubCH, N_{type}^{PSFCH}=N_{subch}^{PSSCH} and the N_{subch}^{PSSCH}·M_{subch,priority}^{PSFCH} PRBs are associated with the N_{subch}^{PSSCH} subch sub-channels of the corresponding PSSCH. The PSFCH resources are first indexed according to an ascending order of the PRB index from

$${N}_{type}^{PSFCH} \times ⌊ \frac{{M}_{subch , priority}^{PSFCH}}{N} ⌋$$

PRBs and then according to an ascending order of the cyclic shift pair index from the N_{CS}^{PSFCH} cyclic shift pairs.

In some aspects, the second UE 120-2 may determine an index of a PSFCH resource for a PSFCH transmission in response to PSSCH reception as (P_{ID}+M_{ID}) mod R_{PRB,CS}^{PSFCH} Where P_{ID} is a physical layer source ID provided by SCI format 2-A or 2-B scheduling the PSSCH reception, and M_{ID} dis the identity of the UE receiving the PSSCH as indicated by higher layers if the UE detects a SCI format 2-A with a cast type indicator field value of “01” (otherwise, M_{ID} is zero).

In some aspects, the second UE 120-2 may be configured with separate PSFCH resources for different SL HARQ-ACK CBs associated with different PSSCH priorities. For example, as shown in FIG. 7D, and by reference number 770, UE 120-2 may have a first group of resource blocks configured for a first SL HARQ-ACK CB for the first PSSCH priority and a second group of resource blocks configured for a second SL HARQ-ACK CB for the second PSSCH priority. In this case, PSFCH resource pools for different SL HARQ-ACK CBs may be frequency division multiplexed (FDM) or time division multiplexed (TDM) together. For example, for FDM combining, different PSFCH resource pools may be configured in different PRBs by configuring the second UE 120-2 with different starting resource blocks and resource block sets. Additionally, or alternatively, for TDM combining, different PSFCH resource pools may be configured in different slots by configuring the second UE 120-2 with different PSFCH periodicities and offsets for the different PSFCH resource pools.

In some aspects, the second UE 120-2 may identify a collision between a first HARQ feedback message generated using a first SL HARQ-ACK CB (associated with a first priority) and a second HARQ feedback message generated using a second SL HARQ-ACK CB (associated with a second priority). For example, when the first SL HARQ-ACK CB is associated with a first PSFCH resource and the second SL HARQ-ACK CB is associated with a second PSFCH resource that at least partially overlaps (e.g., in time and/or frequency resources) with the first PSFCH resource, the second UE 120-2 may identify a collision (e.g., due to the UE capability on maximum number of simultaneous PSFCH transmission or due to limited transmission power). In this case, in some aspects, the second UE 120-2 may select to transmit the first HARQ feedback message and drop the second HARQ feedback message (and may use the first PSFCH resource for transmitting the first HARQ feedback message). For example, the second UE 120-2 may transmit a first HARQ feedback message (PSFCH1) generated using a high priority (HP) SL HARQ-ACK CB and drop a second HARQ feedback message (PSFCH2) generated using a low priority (LP) SL HARQ-ACK CB, as shown in FIG. 7E and by reference number 780.

Additionally, or alternatively, UE 120-2 may multiplex the first HARQ feedback message with the second HARQ feedback message, as shown in FIG. 7E and by reference number 782. For example, UE 120-2 may multiplex the second HARQ feedback message onto the first HARQ feedback message based at least in part on priorities of the respective SL HARQ-ACK CBs. In some aspects, when multiplexing HARQ feedback, the second UE 120-2 may separately encode and separately map HARQ feedback messages to resource elements associated with the high priority HARQ feedback message. For example, as shown by reference number 784, the second UE 120-2 may encode the first HARQ feedback message with a first coding rate and the second HARQ feedback message with a second coding rate, and map the first encoded HARQ feedback message and second encoded HARQ feedback message to respective resource elements associated with PSFCH1. In this case, if a total quantity of coded bits exceeds a PSFCH capacity, the second UE 120-2 may map the higher priority feedback message to resource elements associated with PSFCH1 before mapping the lower priority HARQ feedback message to resource elements associated with PSFCH1. In contrast, as shown by reference number 786, the second UE 120-2 may jointly encode the HARQ feedback messages. For example, the second UE 120-2 may concatenate the first HARQ feedback message and the second HARQ feedback message and jointly encode the concatenated HARQ feedback message onto resource elements associated with PSFCH1. In some aspects, the second UE 120-2 may multiplex the HARQ feedback messages based at least in part on the HARQ feedback messages corresponding to PSSCH communications from the same source UE (e.g., the first UE 120-1).

As indicated above, FIGS. 7A-7E are provided as an example. Other examples may differ from what is described with respect to FIGS. 7A-7E.

FIG. 8 is a diagram illustrating an example process 800 performed, for example, by a UE, in accordance with the present disclosure. Example process 800 is an example where the UE (e.g., UE 120) performs operations associated with sidelink feedback messaging.

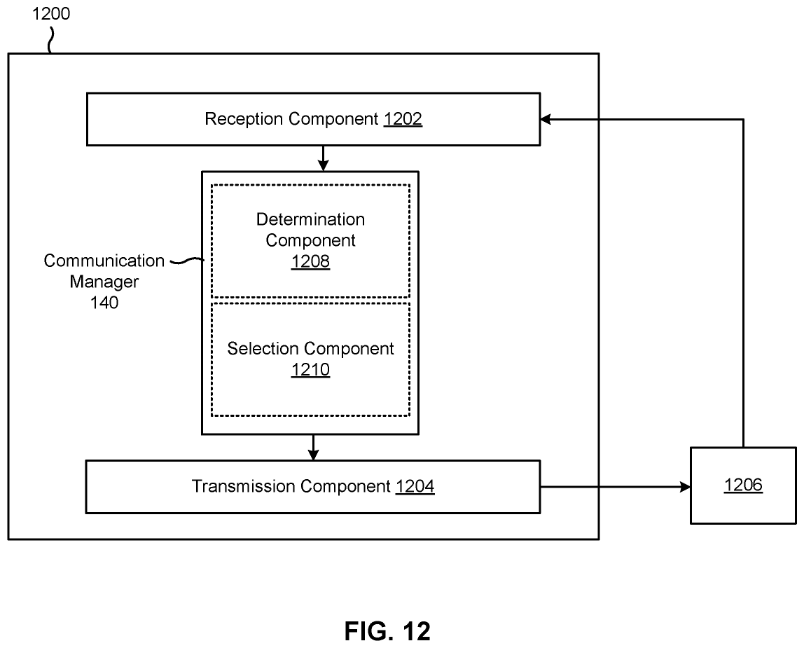

As shown in FIG. 8, in some aspects, process 800 may include receiving a first one or more physical sidelink shared channel communications associated with a first set of physical sidelink shared channel priorities and associated with a first feedback message codebook (block 810). For example, the UE (e.g., using communication manager 140 and/or reception component 1202, depicted in FIG. 12) may receive a first one or more physical sidelink shared channel communications associated with a first set of physical sidelink shared channel priorities, of a plurality of physical sidelink shared channel priorities, and associated with a first feedback message codebook, as described above.

As further shown in FIG. 8, in some aspects, process 800 may include receiving a second one or more physical sidelink shared channel communications associated with a second set of physical sidelink shared channel priorities and associated with a second feedback message codebook (block 820). For example, the UE (e.g., using communication manager 140 and/or reception component 1202, depicted in FIG. 12) may receive a second one or more physical sidelink shared channel communications associated with a second set of physical sidelink shared channel priorities, of the plurality of physical sidelink shared channel priorities, and associated with a second feedback message codebook, as described above.

As further shown in FIG. 8, in some aspects, process 800 may include transmitting, based at least in part on a physical sidelink feedback channel feedback resource configuration, a first feedback message in a first physical sidelink feedback channel feedback resource and a second feedback message in a second physical sidelink feedback channel feedback resource (block 830). For example, the UE (e.g., using communication manager 140 and/or transmission component 1204, depicted in FIG. 12) may transmit, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook, as described above.

Process 800 may include additional aspects, such as any single aspect or any combination of aspects described below and/or in connection with one or more other processes described elsewhere herein.

In a first aspect, the physical sidelink feedback channel feedback resource configuration is common to the plurality of physical sidelink shared channel priorities.

In a second aspect, alone or in combination with the first aspect, the physical sidelink feedback channel feedback resource configuration includes a set of RBs, where the set of RBs is split into a plurality of physical sidelink feedback channel feedback resource block groups (RBGs) based at least in part on a set of sub-channels and on the respective sets of physical sidelink shared channel priorities, and where each RBG, of the plurality of RBGs, includes a plurality of RBs, of the set of RBs, and is associated with a sub-channel and with a set of physical sidelink shared channel priorities.

In a third aspect, alone or in combination with one or more of the first and second aspects, a mapping between the sub-channel and an RBG comprises a frequency first, priority second order.

In a fourth aspect, alone or in combination with one or more of the first through third aspects, a mapping the sub-channel and an RBG comprises a priority first, frequency second order.

In a fifth aspect, alone or in combination with one or more of the first through fourth aspects, process 800 includes determining a size of a physical sidelink feedback channel resource pool for the first physical sidelink feedback channel feedback resource and the second physical sidelink feedback channel feedback resource based at least in part on at least one of a quantity of RBs in a physical sidelink feedback channel feedback RBG, a quantity of RBs for a physical sidelink feedback channel resource, a quantity of cyclic shift pairs, or a quantity of physical sidelink feedback channel resources available for multiplexing feedback information in a physical sidelink feedback channel transmission.

In a sixth aspect, alone or in combination with one or more of the first through fifth aspects, process 800 includes selecting, using a hash function and based at least in part on a UE identifier and on a groupcast identifier associated with a physical sidelink feedback channel resource pool, the first physical sidelink feedback channel feedback resource and the second physical sidelink feedback channel feedback resource.

In a seventh aspect, alone or in combination with one or more of the first through sixth aspects, a coding rate is based at least in part on at least one of a physical sidelink feedback channel format or a physical sidelink shared channel priority.

In an eighth aspect, alone or in combination with one or more of the first through seventh aspects, the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

In a ninth aspect, alone or in combination with one or more of the first through eighth aspects, the first physical sidelink feedback channel resources and second physical sidelink feedback channel resources are subject to at least one of frequency division multiplexing or time division multiplexing.

In a tenth aspect, alone or in combination with one or more of the first through ninth aspects, the first physical sidelink feedback channel resources and the second physical sidelink feedback channel resources are configured in at least one of different physical resource blocks, or different slots.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with sidelink feedback messaging.

As shown in FIG. 9, in some aspects, process 900 may include receiving a first one or more physical sidelink shared channel communications associated with a first set of physical sidelink shared channel priorities and associated with a first feedback message codebook (block 910). For example, the UE (e.g., using communication manager 140) and/or reception component 1202, depicted in FIG. 12) may receive a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource, as described above.

As further shown in FIG. 9, in some aspects, process 900 may include receiving a second one or more physical sidelink shared channel communications associated with a second set of physical sidelink shared channel priorities and associated with a second feedback message codebook (block 920). For example, the UE (e.g., using communication manager 140 and/or reception component 1202, depicted in FIG. 12) may receive a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, as described above. In some aspects, the first physical sidelink feedback channel feedback resource and the second physical sidelink feedback channel feedback resource are at least partially overlapping in time.

As further shown in FIG. 9, in some aspects, process 900 may include transmitting a feedback message in one of a first physical sidelink feedback channel feedback resource or a second physical sidelink feedback channel feedback resource (block 930). For example, the UE (e.g., using communication manager 140 and/or transmission component 1204, depicted in FIG. 12) may transmit a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities, as described above.

Process 900 may include additional aspects, such as any single aspect or any combination of aspects described below and/or in connection with one or more other processes described elsewhere herein.

In a first aspect, the first set of physical sidelink shared channel priorities are a set of high priorities and the second set of physical sidelink shared channel priorities are a set of low priorities relative to the set of high priorities, feedback for the first set of physical sidelink shared channel communications is included in the feedback message, and feedback for the second set of physical sidelink shared channel communications is dropped from the feedback message based at least in part on the respective sets of physical sidelink shared channel priorities.

In a second aspect, alone or in combination with the first aspect, first feedback for the first set of physical sidelink shared channel communications and second feedback for the second set of physical sidelink shared channel communications are multiplexed into the feedback message.

In a third aspect, alone or in combination with one or more of the first and second aspects, the first feedback and the second feedback are separately encoded and separately mapped to resource elements of the one of the first physical sidelink feedback channel feedback resource or the second physical sidelink feedback channel feedback resource.

In a fourth aspect, alone or in combination with one or more of the first through third aspects, the first feedback and the second feedback are concatenated, jointly encoded, and jointly mapped to resource elements of the one of the first physical sidelink feedback channel feedback resource or the second physical sidelink feedback channel feedback resource.

In a fifth aspect, alone or in combination with one or more of the first through fourth aspects, whether the feedback message conveys feedback for the first set of physical sidelink shared channel communications or the second set of physical sidelink shared channel communications is based at least in part on at least one of a radio resource control configuration or a static pre-configuration.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with sidelink feedback messaging.

As shown in FIG. 10, in some aspects, process 1000 may include transmitting a first one or more physical sidelink shared channel communications associated with a first set of physical sidelink shared channel priorities and associated with a first feedback message codebook (block 1010). For example, the UE (e.g., using communication manager 140 and/or transmission component 1204, depicted in FIG. 12) may transmit a first one or more physical sidelink shared channel communications associated with a first set of physical sidelink shared channel priorities, of a plurality of physical sidelink shared channel priorities, and associated with a first feedback message codebook, as described above.

As further shown in FIG. 10, in some aspects, process 1000 may include transmitting a second one or more physical sidelink shared channel communications associated with a second set of physical sidelink shared channel priorities and associated with a second feedback message codebook (block 1020). For example, the UE (e.g., using communication manager 140 and/or transmission component 1204, depicted in FIG. 12) may transmit a second one or more physical sidelink shared channel communications associated with a second set of physical sidelink shared channel priorities, of the plurality of physical sidelink shared channel priorities, and associated with a second feedback message codebook, as described above.

As further shown in FIG. 10, in some aspects, process 1000 may include receiving, based at least in part on a physical sidelink feedback channel feedback resource configuration, a first feedback message in a first physical sidelink feedback channel feedback resource and a second feedback message in a second physical sidelink feedback channel feedback resource (block 1030). For example, the UE (e.g., using communication manager 140) and/or reception component 1202, depicted in FIG. 12) may receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook, as described above.

Process 1000 may include additional aspects, such as any single aspect or any combination of aspects described below and/or in connection with one or more other processes described elsewhere herein.

In a first aspect, the physical sidelink feedback channel feedback resource configuration is common to the plurality of physical sidelink shared channel priorities.

In a second aspect, alone or in combination with the first aspect, the physical sidelink feedback channel feedback resource configuration includes a set of RBs, where the set of RBs is split into a plurality of physical sidelink feedback channel feedback RBGs based at least in part on a set of sub-channels and on the respective sets of physical sidelink shared channel priorities, and where each RBG, of the plurality of RBGs, includes a plurality of RBs, of the set of RBs, and is associated with a sub-channel and with a set of physical sidelink shared channel priorities.

In a third aspect, alone or in combination with one or more of the first and second aspects, a mapping between the sub-channel and an RBG comprises a frequency first, priority second order.

In a fourth aspect, alone or in combination with one or more of the first through third aspects, a mapping the sub-channel and an RBG comprises a priority first, frequency second order.

In a fifth aspect, alone or in combination with one or more of the first through fourth aspects, a size of a physical sidelink feedback channel resource pool for the first physical sidelink feedback channel feedback resource and the second physical sidelink feedback channel feedback resource based at least in part on at least one of a quantity of RBs in a physical sidelink feedback channel feedback RBG, a quantity of RBs for a physical sidelink feedback channel resource, a quantity of cyclic shift pairs, or a quantity of physical sidelink feedback channel resources available for multiplexing feedback information in a physical sidelink feedback channel transmission.

In a sixth aspect, alone or in combination with one or more of the first through fifth aspects, the first physical sidelink feedback channel feedback resource and the second physical sidelink feedback channel feedback resource are selected using a hash function and based at least in part on a UE identifier and on a groupcast identifier associated with a physical sidelink feedback channel resource pool.

In a seventh aspect, alone or in combination with one or more of the first through sixth aspects, a coding rate is based at least in part on at least one of a physical sidelink feedback channel format or a physical sidelink shared channel priority.

In an eighth aspect, alone or in combination with one or more of the first through seventh aspects, the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

In a ninth aspect, alone or in combination with one or more of the first through eighth aspects, the first physical sidelink feedback channel resources and second physical sidelink feedback channel resources are subject to at least one of frequency division multiplexing or time division multiplexing.

In a tenth aspect, alone or in combination with one or more of the first through ninth aspects, the first physical sidelink feedback channel resources and the second physical sidelink feedback channel resources are configured in at least one of different physical resource blocks, or different slots.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with sidelink feedback messaging.

As shown in FIG. 11, in some aspects, process 1100 may include transmitting a first one or more physical sidelink shared channel communications associated with a first set of physical sidelink shared channel priorities and associated with a first feedback message codebook (block 1110). For example, the UE (e.g., using communication manager 140 and/or transmission component 1204, depicted in FIG. 12) may transmit a first one or more physical sidelink shared channel communications associated with a first set of physical sidelink shared channel priorities, of a plurality of physical sidelink shared channel priorities, and associated with a first feedback message codebook, where the first feedback message codebook is specific to the first set of physical sidelink shared channel priorities and is associated with a first physical sidelink feedback channel feedback resource, as described above.

As further shown in FIG. 11, in some aspects, process 1100 may include transmitting a second one or more physical sidelink shared channel communications associated with a second set of physical sidelink shared channel priorities and associated with a second feedback message codebook (block 1120). For example, the UE (e.g., using communication manager 140 and/or transmission component 1204, depicted in FIG. 12) may transmit a second one or more physical sidelink shared channel communications associated with a second set of physical sidelink shared channel priorities, of the plurality of physical sidelink shared channel priorities, and associated with a second feedback message codebook, where the second feedback message codebook is specific to the second set of physical sidelink shared channel priorities and is associated with a second physical sidelink feedback channel feedback resource, as described above. In some aspects, the first physical sidelink feedback channel feedback resource and the second physical sidelink feedback channel feedback resource are at least partially overlapping in time.

As further shown in FIG. 11, in some aspects, process 1100 may include receiving a feedback message in one of the first physical sidelink feedback channel feedback resource or the second physical sidelink feedback channel feedback resource (block 1130). For example, the UE (e.g., using communication manager 140) and/or reception component 1202, depicted in FIG. 12) may receive a feedback message in one of the first physical sidelink feedback channel feedback resource or the second physical sidelink feedback channel feedback resource, where the feedback message conveys feedback for at least one of the first set of physical sidelink shared channel communications or the second set of physical sidelink shared channel communications based at least in part on respective sets of physical sidelink shared channel priorities, as described above.

Process 1100 may include additional aspects, such as any single aspect or any combination of aspects described below and/or in connection with one or more other processes described elsewhere herein.

In a first aspect, the first set of physical sidelink shared channel priorities are a set of high priorities and the second set of physical sidelink shared channel priorities are a set of low priorities relative to the set of high priorities, feedback for the first set of physical sidelink shared channel communications is included in the feedback message, and feedback for the second set of physical sidelink shared channel communications is dropped from the feedback message based at least in part on the respective sets of physical sidelink shared channel priorities.

In a second aspect, alone or in combination with the first aspect, first feedback for the first set of physical sidelink shared channel communications and second feedback for the second set of physical sidelink shared channel communications are multiplexed into the feedback message.

In a third aspect, alone or in combination with one or more of the first and second aspects, the first feedback and the second feedback are separately encoded and separately mapped to resource elements of the one of the first physical sidelink feedback channel feedback resource or the second physical sidelink feedback channel feedback resource.

In a fourth aspect, alone or in combination with one or more of the first through third aspects, the first feedback and the second feedback are concatenated, jointly encoded, and jointly mapped to resource elements of the one of the first physical sidelink feedback channel feedback resource or the second physical sidelink feedback channel feedback resource.

In a fifth aspect, alone or in combination with one or more of the first through fourth aspects, whether the feedback message conveys feedback for the first set of physical sidelink shared channel communications or the second set of physical sidelink shared channel communications is based at least in part on at least one of a radio resource control configuration or a static pre-configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a determination component 1208 or a selection component 1210, among other examples.

In some aspects, the apparatus 1200 may be configured to perform one or more operations described herein in connection with FIGS. 7A-7E. Additionally, or alternatively, the apparatus 1200 may be configured to perform one or more processes described herein, such as process 800 of FIG. 8, process 900 of FIG. 9, process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive a first one or more physical sidelink shared channel communications associated with a first set of physical sidelink shared channel priorities, of a plurality of physical sidelink shared channel priorities, and associated with a first feedback message codebook. The reception component 1202 may receive a second one or more physical sidelink shared channel communications associated with a second set of physical sidelink shared channel priorities, of the plurality of physical sidelink shared channel priorities, and associated with a second feedback message codebook. The transmission component 1204 may transmit, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

The determination component 1208 may determine a size of a physical sidelink feedback channel resource pool for the first physical sidelink feedback channel feedback resource and the second physical sidelink feedback channel feedback resource based at least in part on at least one of a quantity of RBs in a physical sidelink feedback channel feedback, a quantity of RBs for a physical sidelink feedback channel resource, a quantity of cyclic shift pairs, or a quantity of physical sidelink feedback channel resources available for multiplexing feedback information in a physical sidelink feedback channel transmission. The selection component 1210 may select, using a hash function and based at least in part on a UE identifier and on a groupcast identifier associated with a physical sidelink feedback channel resource pool, the first physical sidelink feedback channel feedback resource and the second physical sidelink feedback channel feedback resource.

The reception component 1202 may receive a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource. The reception component 1202 may receive a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource, and wherein the first physical sidelink feedback channel feedback resource and the second physical sidelink feedback channel feedback resource are at least partially overlapping in time. The transmission component 1204 may transmit a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

The transmission component 1204 may transmit a first one or more physical sidelink shared channel communications associated with a first set of physical sidelink shared channel priorities, of a plurality of physical sidelink shared channel priorities, and associated with a first feedback message codebook. The transmission component 1204 may transmit a second one or more physical sidelink shared channel communications associated with a second set of physical sidelink shared channel priorities, of the plurality of physical sidelink shared channel priorities, and associated with a second feedback message codebook. The reception component 1202 may receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

The transmission component 1204 may transmit a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource. The transmission component 1204 may transmit a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource, and wherein the first physical sidelink feedback channel feedback resource and the second physical sidelink feedback channel feedback resource are at least partially overlapping in time. The reception component 1202 may receive a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving a first one or more physical sidelink shared channel communications associated with a first set of physical sidelink shared channel priorities, of a plurality of physical sidelink shared channel priorities, and associated with a first feedback message codebook; and receiving a second one or more physical sidelink shared channel communications associated with a second set of physical sidelink shared channel priorities, of the plurality of physical sidelink shared channel priorities, and associated with a second feedback message codebook; transmitting, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Aspect 2: The method of Aspect 1, wherein the physical sidelink feedback channel feedback resource configuration is common to the plurality of physical sidelink shared channel priorities.

Aspect 3: The method of Aspect 2, wherein the physical sidelink feedback channel feedback resource configuration includes a set of resource blocks (RBs), wherein the set of RBs is split into a plurality of physical sidelink feedback channel feedback resource block groups (RBGs) based at least in part on a set of sub-channels and on the respective sets of physical sidelink shared channel priorities, and wherein each RBG, of the plurality of RBGs, includes a plurality of RBs, of the set of RBs, and is associated with a sub-channel and with a set of physical sidelink shared channel priorities.

Aspect 4: The method of Aspect 3, wherein a mapping between the sub-channel and an RBG comprises a frequency first, priority second order.

Aspect 5: The method of any of Aspects 3 to 4, wherein a mapping between the sub-channel and an RBG comprises a priority first, frequency second order.

Aspect 6: The method of any of Aspects 2 to 5, further comprising: determining a size of a physical sidelink feedback channel resource pool for the first physical sidelink feedback channel feedback resource and the second physical sidelink feedback channel feedback resource based at least in part on at least one of: a quantity of resource blocks (RBs) in a physical sidelink feedback channel feedback resource block group (RBG), a quantity of RBs for a physical sidelink feedback channel resource, a quantity of cyclic shift pairs, or a quantity of physical sidelink feedback channel resources available for multiplexing feedback information in a physical sidelink feedback channel transmission.

Aspect 7: The method of any of Aspects 2 to 5, further comprising: selecting, using a hash function and based at least in part on a UE identifier and on a groupcast identifier associated with a physical sidelink feedback channel resource pool, the first physical sidelink feedback channel feedback resource and the second physical sidelink feedback channel feedback resource.

Aspect 8: The method of any of Aspects 2 to 7, wherein a coding rate is based at least in part on at least one of a physical sidelink feedback channel format or a physical sidelink shared channel priority.

Aspect 9: The method of any of Aspects 1 to 8, wherein the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

Aspect 10: The method of Aspect 9, wherein the first physical sidelink feedback channel resources and second physical sidelink feedback channel resources are subject to at least one of frequency division multiplexing or time division multiplexing.

Aspect 11: The method of any of Aspects 1 to 10, wherein the first physical sidelink feedback channel resources and the second physical sidelink feedback channel resources are configured in at least one of: different physical resource blocks, or different slots.

Aspect 12: A method of wireless communication performed by a user equipment (UE), comprising: receiving a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource: receiving a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource, wherein the first physical sidelink feedback channel feedback resource and the second physical sidelink feedback channel feedback resource are at least partially overlapping in time; and transmitting a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

Aspect 13: The method of Aspect 12, wherein the first set of physical sidelink shared channel priorities are a set of high priorities and the second set of physical sidelink shared channel priorities are a set of low priorities relative to the set of high priorities, and wherein feedback for the first set of physical sidelink shared channel communications is included in the feedback message, and feedback for the second set of physical sidelink shared channel communications is dropped from the feedback message based at least in part on the respective sets of physical sidelink shared channel priorities.

Aspect 14: The method of any of Aspects 12 to 13, wherein first feedback for the first set of physical sidelink shared channel communications and second feedback for the second set of physical sidelink shared channel communications are multiplexed into the feedback message.

Aspect 15: The method of Aspect 14, wherein the first feedback and the second feedback are separately encoded and separately mapped to resource elements of the one of the first physical sidelink feedback channel feedback resource or the second physical sidelink feedback channel feedback resource.

Aspect 16: The method of any of Aspects 14 to 15, wherein the first feedback and the second feedback are concatenated, jointly encoded, and jointly mapped to resource elements of the one of the first physical sidelink feedback channel feedback resource or the second physical sidelink feedback channel feedback resource.

Aspect 17: The method of any of Aspects 12 to 16, wherein whether the feedback message conveys feedback for the first set of physical sidelink shared channel communications or the second set of physical sidelink shared channel communications is based at least in part on at least one of a radio resource control configuration or a static pre-configuration.

Aspect 18: A method of wireless communication performed by a user equipment (UE), comprising: transmitting a first one or more physical sidelink shared channel communications associated with a first set of physical sidelink shared channel priorities, of a plurality of physical sidelink shared channel priorities, and associated with a first feedback message codebook: transmitting a second one or more physical sidelink shared channel communications associated with a second set of physical sidelink shared channel priorities, of the plurality of physical sidelink shared channel priorities, and associated with a second feedback message codebook; and receiving, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

Aspect 19: The method of Aspect 18, wherein the physical sidelink feedback channel feedback resource configuration is common to the plurality of physical sidelink shared channel priorities.

Aspect 20: The method of Aspect 19, wherein the physical sidelink feedback channel feedback resource configuration includes a set of resource blocks (RBs), wherein the set of RBs is split into a plurality of physical sidelink feedback channel feedback resource block groups (RBGs) based at least in part on a set of sub-channels and on the respective sets of physical sidelink shared channel priorities, and wherein each RBG, of the plurality of RBGs, includes a plurality of RBs, of the set of RBs, and is associated with a sub-channel and with a set of physical sidelink shared channel priorities.

Aspect 21: The method of Aspect 20, wherein a mapping between the sub-channel and an RBG comprises a frequency first, priority second order.

Aspect 22: The method of any of Aspects 18 to 21, wherein a mapping between the sub-channel and an RBG comprises a priority first, frequency second order.

Aspect 23: The method of any of Aspects 19 to 22, wherein a size of a physical sidelink feedback channel resource pool for the first physical sidelink feedback channel feedback resource and the second physical sidelink feedback channel feedback resource based at least in part on at least one of: a quantity of resource blocks (RBs) in a physical sidelink feedback channel feedback resource block group (RBG), a quantity of RBs for a physical sidelink feedback channel resource, a quantity of cyclic shift pairs, or a quantity of physical sidelink feedback channel resources available for multiplexing feedback information in a physical sidelink feedback channel transmission.

Aspect 24: The method of any of Aspects 19 to 23, wherein the first physical sidelink feedback channel feedback resource and the second physical sidelink feedback channel feedback resource are selected using a hash function and based at least in part on a UE identifier and on a groupcast identifier associated with a physical sidelink feedback channel resource pool.

Aspect 25: The method of any of Aspects 19 to 24, wherein a coding rate is based at least in part on at least one of a physical sidelink feedback channel format or a physical sidelink shared channel priority.

Aspect 26: The method of any of Aspects 18 to 25, wherein the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

Aspect 27: The method of Aspect 26, wherein the first physical sidelink feedback channel resources and second physical sidelink feedback channel resources are subject to at least one of frequency division multiplexing or time division multiplexing.

Aspect 28: The method of any of Aspects 26 to 27, wherein the first physical sidelink feedback channel resources and the second physical sidelink feedback channel resources are configured in at least one of: different physical resource blocks, or different slots.

Aspect 29: A method of wireless communication performed by a user equipment (UE), comprising: transmitting a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource: transmitting a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource, wherein the first physical sidelink feedback channel feedback resource and the second physical sidelink feedback channel feedback resource are at least partially overlapping in time; and receiving a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

Aspect 30: The method of Aspect 29, wherein the first set of physical sidelink shared channel priorities are a set of high priorities and the second set of physical sidelink shared channel priorities are a set of low priorities relative to the set of high priorities, and wherein feedback for the first set of physical sidelink shared channel communications is included in the feedback message, and feedback for the second set of physical sidelink shared channel communications is dropped from the feedback message based at least in part on the respective sets of physical sidelink shared channel priorities.

Aspect 31: The method of any of Aspects 29 to 30, wherein first feedback for the first set of physical sidelink shared channel communications and second feedback for the second set of physical sidelink shared channel communications are multiplexed into the feedback message.

Aspect 32: The method of Aspect 31, wherein the first feedback and the second feedback are separately encoded and separately mapped to resource elements of the one of the first physical sidelink feedback channel feedback resource or the second physical sidelink feedback channel feedback resource.

Aspect 33: The method of any of Aspects 31 to 32, wherein the first feedback and the second feedback are concatenated, jointly encoded, and jointly mapped to resource elements of the one of the first physical sidelink feedback channel feedback resource or the second physical sidelink feedback channel feedback resource.

Aspect 34: The method of any of Aspects 29 to 33, wherein whether the feedback message conveys feedback for the first set of physical sidelink shared channel communications or the second set of physical sidelink shared channel communications is based at least in part on at least one of a radio resource control configuration or a static pre-configuration.

Aspect 35: An apparatus for wireless communication at a device, comprising a processor: memory coupled with the processor; and instructions stored in the memory and executable by the processor to cause the apparatus to perform the method of one or more of Aspects 1-11.

Aspect 36: A device for wireless communication, comprising a memory and one or more processors coupled to the memory, the one or more processors configured to perform the method of one or more of Aspects 1-11.

Aspect 37: An apparatus for wireless communication, comprising at least one means for performing the method of one or more of Aspects 1-11.

Aspect 38: A non-transitory computer-readable medium storing code for wireless communication, the code comprising instructions executable by a processor to perform the method of one or more of Aspects 1-11.

Aspect 39: A non-transitory computer-readable medium storing a set of instructions for wireless communication, the set of instructions comprising one or more instructions that, when executed by one or more processors of a device, cause the device to perform the method of one or more of Aspects 1-11.

Aspect 40: An apparatus for wireless communication at a device, comprising a processor: memory coupled with the processor; and instructions stored in the memory and executable by the processor to cause the apparatus to perform the method of one or more of Aspects 12-17.

Aspect 41: A device for wireless communication, comprising a memory and one or more processors coupled to the memory, the one or more processors configured to perform the method of one or more of Aspects 12-17.

Aspect 42: An apparatus for wireless communication, comprising at least one means for performing the method of one or more of Aspects 12-17.

Aspect 43: A non-transitory computer-readable medium storing code for wireless communication, the code comprising instructions executable by a processor to perform the method of one or more of Aspects 12-17.

Aspect 44: A non-transitory computer-readable medium storing a set of instructions for wireless communication, the set of instructions comprising one or more instructions that, when executed by one or more processors of a device, cause the device to perform the method of one or more of Aspects 12-17.

Aspect 45: An apparatus for wireless communication at a device, comprising a processor: memory coupled with the processor; and instructions stored in the memory and executable by the processor to cause the apparatus to perform the method of one or more of Aspects 18-28.

Aspect 46: A device for wireless communication, comprising a memory and one or more processors coupled to the memory, the one or more processors configured to perform the method of one or more of Aspects 18-28.

Aspect 47: An apparatus for wireless communication, comprising at least one means for performing the method of one or more of Aspects 18-28.

Aspect 48: A non-transitory computer-readable medium storing code for wireless communication, the code comprising instructions executable by a processor to perform the method of one or more of Aspects 18-28.

Aspect 49: A non-transitory computer-readable medium storing a set of instructions for wireless communication, the set of instructions comprising one or more instructions that, when executed by one or more processors of a device, cause the device to perform the method of one or more of Aspects 18-28.

Aspect 50: An apparatus for wireless communication at a device, comprising a processor: memory coupled with the processor; and instructions stored in the memory and executable by the processor to cause the apparatus to perform the method of one or more of Aspects 29-34.

Aspect 51: A device for wireless communication, comprising a memory and one or more processors coupled to the memory, the one or more processors configured to perform the method of one or more of Aspects 29-34.

Aspect 52: An apparatus for wireless communication, comprising at least one means for performing the method of one or more of Aspects 29-34.

Aspect 53: A non-transitory computer-readable medium storing code for wireless communication, the code comprising instructions executable by a processor to perform the method of one or more of Aspects 29-34.

Aspect 54: A non-transitory computer-readable medium storing a set of instructions for wireless communication, the set of instructions comprising one or more instructions that, when executed by one or more processors of a device, cause the device to perform the method of one or more of Aspects 29-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein. “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a first one or more physical sidelink shared channel communications associated with a first set of physical sidelink shared channel priorities, of a plurality of physical sidelink shared channel priorities, and associated with a first feedback message codebook;
receive a second one or more physical sidelink shared channel communications associated with a second set of physical sidelink shared channel priorities, of the plurality of physical sidelink shared channel priorities, and associated with a second feedback message codebook; and
transmit, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

2. The UE of claim 1, wherein the physical sidelink feedback channel feedback resource configuration is common to the plurality of physical sidelink shared channel priorities.

3. The UE of claim 2, wherein the physical sidelink feedback channel feedback resource configuration includes a set of resource blocks (RBs), wherein the set of RBs is split into a plurality of physical sidelink feedback channel feedback resource block groups (RBGs) based at least in part on a set of sub-channels and on the respective sets of physical sidelink shared channel priorities, and
wherein each RBG, of the plurality of RBGs, includes a plurality of RBs, of the set of RBs, and is associated with a sub-channel and with a set of physical sidelink shared channel priorities.

4. The UE of claim 3, wherein a mapping between the sub-channel and an RBG comprises a frequency first, priority second order.

5. The UE of claim 3, wherein a mapping between the sub-channel and an RBG comprises a priority first, frequency second order.

6. The UE of claim 2, wherein the one or more processors are further configured to:
determine a size of a physical sidelink feedback channel resource pool for the first physical sidelink feedback channel feedback resource and the second physical sidelink feedback channel feedback resource based at least in part on at least one of:
a quantity of resource blocks (RBs) in a physical sidelink feedback channel feedback resource block group (RBG),
a quantity of RBs for a physical sidelink feedback channel resource,
a quantity of cyclic shift pairs, or
a quantity of physical sidelink feedback channel resources available for multiplexing feedback information in a physical sidelink feedback channel transmission.

7. The UE of claim 2, wherein the one or more processors are further configured to:
select, using a hash function and based at least in part on a UE identifier and on a groupcast identifier associated with a physical sidelink feedback channel resource pool, the first physical sidelink feedback channel feedback resource and the second physical sidelink feedback channel feedback resource.

8. The UE of claim 2, wherein a coding rate is based at least in part on at least one of a physical sidelink feedback channel format or a physical sidelink shared channel priority.

9. The UE of claim 1, wherein the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

10. The UE of claim 9, wherein the first physical sidelink feedback channel resources and second physical sidelink feedback channel resources are subject to at least one of frequency division multiplexing or time division multiplexing.

11. The UE of claim 9, wherein the first physical sidelink feedback channel resources and the second physical sidelink feedback channel resources are configured in at least one of:
different physical resource blocks, or
different slots.

12. A UE for wireless communication, comprising:
a memory; and
one or more processors, coupled to the memory, configured to:
receive a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource;
receive a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource,
wherein the first physical sidelink feedback channel feedback resource and the second physical sidelink feedback channel feedback resource are at least partially overlapping in time; and
transmit a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

13. The UE of claim 12, wherein the first set of physical sidelink shared channel priorities are a set of high priorities and the second set of physical sidelink shared channel priorities are a set of low priorities relative to the set of high priorities, and
wherein feedback for the first set of physical sidelink shared channel communications is included in the feedback message, and feedback for the second set of physical sidelink shared channel communications is dropped from the feedback message based at least in part on the respective sets of physical sidelink shared channel priorities.

14. The UE of claim 12, wherein first feedback for the first set of physical sidelink shared channel communications and second feedback for the second set of physical sidelink shared channel communications are multiplexed into the feedback message.

15. The UE of claim 14, wherein the first feedback and the second feedback are separately encoded and separately mapped to resource elements of the one of the first physical sidelink feedback channel feedback resource or the second physical sidelink feedback channel feedback resource.

16. The UE of claim 14, wherein the first feedback and the second feedback are concatenated, jointly encoded, and jointly mapped to resource elements of the one of the first physical sidelink feedback channel feedback resource or the second physical sidelink feedback channel feedback resource.

17. The UE of claim 12, wherein whether the feedback message conveys feedback for the first set of physical sidelink shared channel communications or the second set of physical sidelink shared channel communications is based at least in part on at least one of a radio resource control configuration or a static pre-configuration.

18. A UE for wireless communication, comprising:
a memory; and
one or more processors, coupled to the memory, configured to:
transmit a first one or more physical sidelink shared channel communications associated with a first set of physical sidelink shared channel priorities, of a plurality of physical sidelink shared channel priorities, and associated with a first feedback message codebook;
transmit a second one or more physical sidelink shared channel communications associated with a second set of physical sidelink shared channel priorities, of the plurality of physical sidelink shared channel priorities, and associated with a second feedback message codebook; and
receive, based at least in part on a physical sidelink feedback channel feedback resource configuration, a first feedback message in a first physical sidelink feedback channel feedback resource associated with the first feedback message codebook and a second feedback message in a second physical sidelink feedback channel feedback resource associated with the second feedback message codebook.

19. The UE of claim 18, wherein the physical sidelink feedback channel feedback resource configuration is common to the plurality of physical sidelink shared channel priorities.

20. The UE of claim 19, wherein the physical sidelink feedback channel feedback resource configuration includes a set of resource blocks (RBs), wherein the set of RBs is split into a plurality of physical sidelink feedback channel feedback resource block groups (RBGs) based at least in part on a set of sub-channels and on the respective sets of physical sidelink shared channel priorities, and
wherein each RBG, of the plurality of RBGs, includes a plurality of RBs, of the set of RBs, and is associated with a sub-channel and with a set of physical sidelink shared channel priorities.

21. The UE of claim 20, wherein a mapping between the sub-channel and an RBG comprises a frequency first, priority second order.

22. The UE of claim 20, wherein a mapping between the sub-channel and an RBG comprises a priority first, frequency second order.

23. The UE of claim 19, wherein a size of a physical sidelink feedback channel resource pool for the first physical sidelink feedback channel feedback resource and the second physical sidelink feedback channel feedback resource based at least in part on at least one of:
a quantity of resource blocks (RBs) in a physical sidelink feedback channel feedback resource block group (RBG),
a quantity of RBs for a physical sidelink feedback channel resource,
a quantity of cyclic shift pairs, or
a quantity of physical sidelink feedback channel resources available for multiplexing feedback information in a physical sidelink feedback channel transmission.

24. The UE of claim 19, wherein the first physical sidelink feedback channel feedback resource and the second physical sidelink feedback channel feedback resource are selected using a hash function and based at least in part on a UE identifier and on a groupcast identifier associated with a physical sidelink feedback channel resource pool.

25. The UE of claim 19, wherein a coding rate is based at least in part on at least one of a physical sidelink feedback channel format or a physical sidelink shared channel priority.

26. The UE of claim 18, wherein the physical sidelink feedback channel feedback resource configuration comprises first physical sidelink feedback channel resources configured for the first set of physical sidelink shared channel priorities and second physical sidelink feedback channel resources configured for the second set of physical sidelink shared channel priorities.

27. The UE of claim 26, wherein the first physical sidelink feedback channel resources and second physical sidelink feedback channel resources are subject to at least one of frequency division multiplexing or time division multiplexing.

28. The UE of claim 26, wherein the first physical sidelink feedback channel resources and the second physical sidelink feedback channel resources are configured in at least one of:
different physical resource blocks, or
different slots.

29. A UE for wireless communication, comprising:
a memory; and
one or more processors, coupled to the memory, configured to:
transmit a first one or more physical sidelink shared channel communications associated with a first set of physical sidelink shared channel priorities, of a plurality of physical sidelink shared channel priorities, and associated with a first feedback message codebook, wherein the first feedback message codebook is specific to the first set of physical sidelink shared channel priorities and is associated with a first physical sidelink feedback channel feedback resource;
transmit a second one or more physical sidelink shared channel communications associated with a second set of physical sidelink shared channel priorities, of the plurality of physical sidelink shared channel priorities, and associated with a second feedback message codebook, wherein the second feedback message codebook is specific to the second set of physical sidelink shared channel priorities and is associated with a second physical sidelink feedback channel feedback resource,
wherein the first physical sidelink feedback channel feedback resource and the second physical sidelink feedback channel feedback resource are at least partially overlapping in time; and
receive a feedback message in one of the first physical sidelink feedback channel feedback resource or the second physical sidelink feedback channel feedback resource, wherein the feedback message conveys feedback for at least one of the first set of physical sidelink shared channel communications or the second set of physical sidelink shared channel communications based at least in part on respective sets of physical sidelink shared channel priorities.

30. The UE of claim 29, wherein the first set of physical sidelink shared channel priorities are a set of high priorities and the second set of physical sidelink shared channel priorities are a set of low priorities relative to the set of high priorities, and
wherein feedback for the first set of physical sidelink shared channel communications is included in the feedback message, and feedback for the second set of physical sidelink shared channel communications is dropped from the feedback message based at least in part on the respective sets of physical sidelink shared channel priorities.

31. The UE of claim 29, wherein first feedback for the first set of physical sidelink shared channel communications and second feedback for the second set of physical sidelink shared channel communications are multiplexed into the feedback message.

32. The UE of claim 31, wherein the first feedback and the second feedback are separately encoded and separately mapped to resource elements of the one of the first physical sidelink feedback channel feedback resource or the second physical sidelink feedback channel feedback resource.

33. The UE of claim 31, wherein the first feedback and the second feedback are concatenated, jointly encoded, and jointly mapped to resource elements of the one of the first physical sidelink feedback channel feedback resource or the second physical sidelink feedback channel feedback resource.

34. The UE of claim 29, wherein whether the feedback message conveys feedback for the first set of physical sidelink shared channel communications or the second set of physical sidelink shared channel communications is based at least in part on at least one of a radio resource control configuration or a static pre-configuration.
